(19) United States
(12) Patent Application Publication
(10) Pub. No.: US 2010/0101899 A1
(43) Pub. Date: Apr. 29, 2010

(54) BRAKE CALIPER INCLUDING HEAT PIPES

(76) Inventor: Brian G. Finkel, Sterling Heights, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 12/260,578

(22) Filed: Oct. 29, 2008

(51) Int. Cl. F16D 55/02; F16D 65/827

(52) U.S. Cl. 188/71.6; 188/264 R

(57) ABSTRACT

A brake caliper including a caliper body and heat pipes at least partially embedded within the caliper body. The caliper body includes spaced inboard and outboard portions. In addition, at least one of the portions includes piston bores. The caliper body further includes a connector between the inboard and outboard portions whose spacing permits brake pads and a periphery of a brake rotor to be received between the inboard and outboard portions. Also, the brake caliper includes pistons disposed in the piston bores to press the brake pads against the periphery of the brake rotor when brake fluid moves the pistons and the brake pads toward the brake rotor. As the brake pads heat the brake caliper, the heat pipes transfer heat away from the piston bores thereby cooling the brake caliper and brake fluid in, around, or near the piston bores.

### BACKGROUND

1. Field of the Invention

Embodiments of the present invention relate to a brake caliper including heat pipes for a brake.

2. Background Art

Disk type brakes include a brake caliper, brake pads, and a brake rotor. When the brake pads contact opposite sides of the brake rotor, friction causes the brake pads to heat. The brake pads can reach temperatures over 700° F. As the temperature of the brake pads increases, heat transfers from the brake pads to one or more pistons in the brake caliper. As a result, the brake caliper and brake fluid heat to higher temperatures. However, if the brake fluid or brake caliper overheat, then a number of problems may occur.

If the brake fluid overheats, the brake fluid may boil and reduce the braking efficiency of a motor vehicle. Typically, regular brake fluid boils at about 350° F. A high-temperature brake fluid usually boils between 400 and 500° F. In addition, if the brake fluid overheats then the brake caliper may experience excessive wear or damage, thus reducing the life of the brake caliper. Furthermore, if the brake fluid overheats, the brake may fail and endanger the driver of the vehicle as well as another driver or pedestrian. For example, the brake fluid may overheat and cause the driver of the vehicle to experience dead pedal. Dead pedal occurs when the brake fluid has overheated and the driver is required to move the brake pedal closer to a floor board of the vehicle to exert the same amount of braking force before the brake fluid overheated.

If the brake caliper overheats, the brake caliper may excessively heat and increase the pressure of a tire in the vehicle. Tire pressure can be important to the driver's ability to handle the vehicle. In addition, tire pressure can impact the fuel economy of the vehicle. The brake caliper can reach temperatures as high as 500° F., which can increase the pressure of the tire and reduce the driver's ability to handle the vehicle. In addition, if the brake caliper excessively heats the tire, then the tire may melt and cause the tire to blow out, which could endanger the lives of others as well as reduce the performance of the vehicle.

Various attempts have been made to cool brake fluid in a motor vehicle. One approach is described in U.S. Pat. No. 6,722,476 entitled “Caliper for a Disk Brake for a High-Performance Motor” which involves a fluid circuit in lower walls of the side portions of a body of the caliper. The fluid circuit includes wells and connecting ducts. The wells are formed in lower walls of the side portions of a body of the caliper and the connecting ducts connect the wells into fluid communication with one another. A cooling fluid, such as water, flows through the wells and connecting ducts to cool the brake fluid.

However, an improved brake caliper is desired for cooling brake fluid in the brake caliper more efficiently and effectively than prior calipers. Also, it may be desirable to cool brake fluid near pistons in the brake caliper more efficiently and effectively than prior brake calipers, especially if the brake fluid becomes hottest near the pistons compared to brake fluid elsewhere in the brake caliper.

### SUMMARY

In a first embodiment, a brake caliper including a caliper body and heat pipes is provided. The heat pipes are at least partially embedded within the caliper body. The caliper body includes an inboard portion, an outboard portion, and a connector. The inboard portion is spaced from the outboard portion and at least one of the portions includes piston bores. The connector is between the inboard and outboard portions whose spacing permits brake pads and a periphery of a brake rotor to be received between the inboard and outboard portions. Also, the brake caliper includes pistons disposed in the piston bores to press the brake pads against the periphery of the brake rotor. The pistons press the brake pads against the periphery of the brake rotor when brake fluid moves the pistons and the brake pads toward the brake rotor. As the brake pads heat the brake caliper, the heat pipes transfer heat away from the piston bores thereby cooling the brake fluid in the piston bores.

In another embodiment, a disk brake is provided. The disk brake includes a brake caliper having piston bores and one or more heat pipes. The heat pipes are at least partially embedded within the brake caliper. In operation, the heat pipes transfer heat away from the piston bores thereby cooling brake fluid in the piston bores.

### BRIEF DESCRIPTION OF THE DRAWINGS

FIG. 1 is a perspective view illustrating a brake caliper receiving brake pads and a periphery of a brake rotor;

FIG. 2 is a cross-sectional view taken along line 2-2 of FIG. 1 illustrating the brake caliper having a caliper body, heat pipes, and pistons for pressing the brake pads against the periphery of the brake rotor;

FIG. 3 is a partial cut-away view illustrating operation of a working fluid in the heat pipes;

FIG. 4 is an exploded perspective view similar to FIG. 1, but illustrating the brake rotor, the caliper body, the brake pads, the pistons, and the heat pipes spaced apart from each other.

FIG. 5 is a top view illustrating the heat pipes at least partially embedded within the caliper body and positioned near piston bores in the caliper body;

FIG. 6 is a cross-sectional view taken along line 6-6 of FIG. 5 illustrating the heat pipes spaced from the piston bores and having a shortest distance “D” between the heat pipes and the piston bores;

FIG. 7(a) is a side elevational view illustrating the brake caliper having a radiator including an inboard radiator portion with inboard fins;

FIG. 7(b) is a side elevational view illustrating the radiator having an outboard radiator portion and fins extending in the same direction on both the inboard radiator portion and the outboard radiator portion;

FIG. 7(c) is a side elevational view illustrating the radiator having fins extending in generally opposite directions on both the inboard radiator portion and the outboard radiator portion.

### DETAILED DESCRIPTION

Embodiments of the present invention generally provide a brake caliper including heat pipes for cooling the brake caliper as well as the brake fluid in the brake caliper. The heat pipes cool the brake fluid in the piston bores. In addition, the heat pipes may cool the brake fluid in other portions of the brake caliper, such as the brake fluid flowing through a fluid passage in the brake caliper.

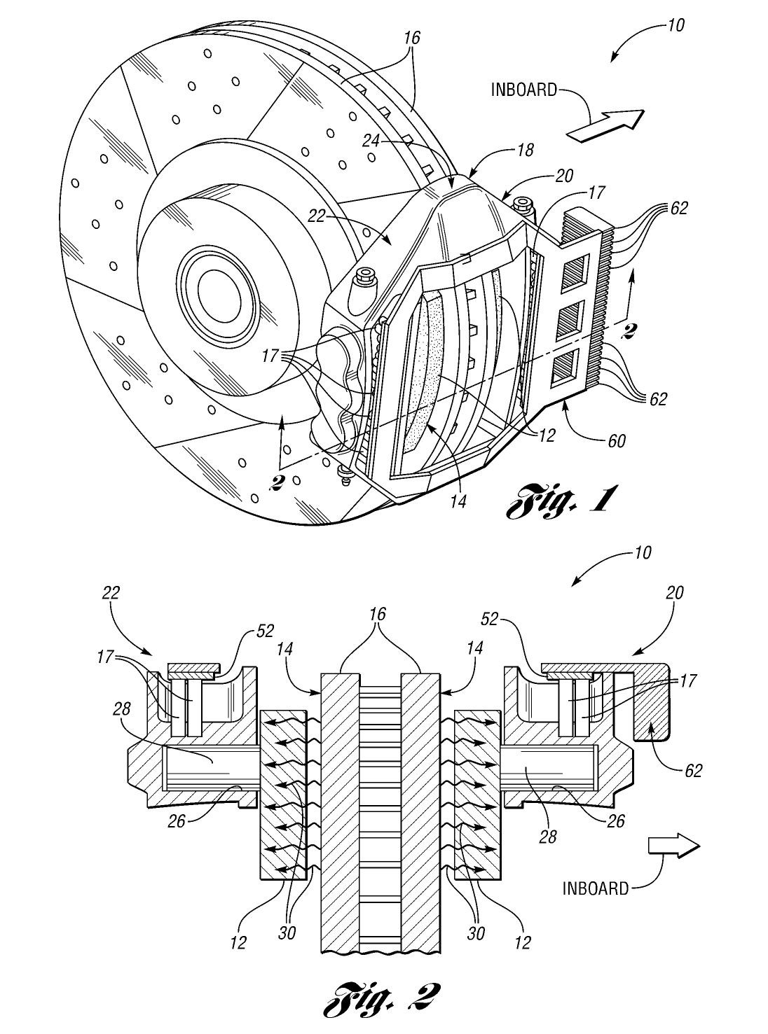

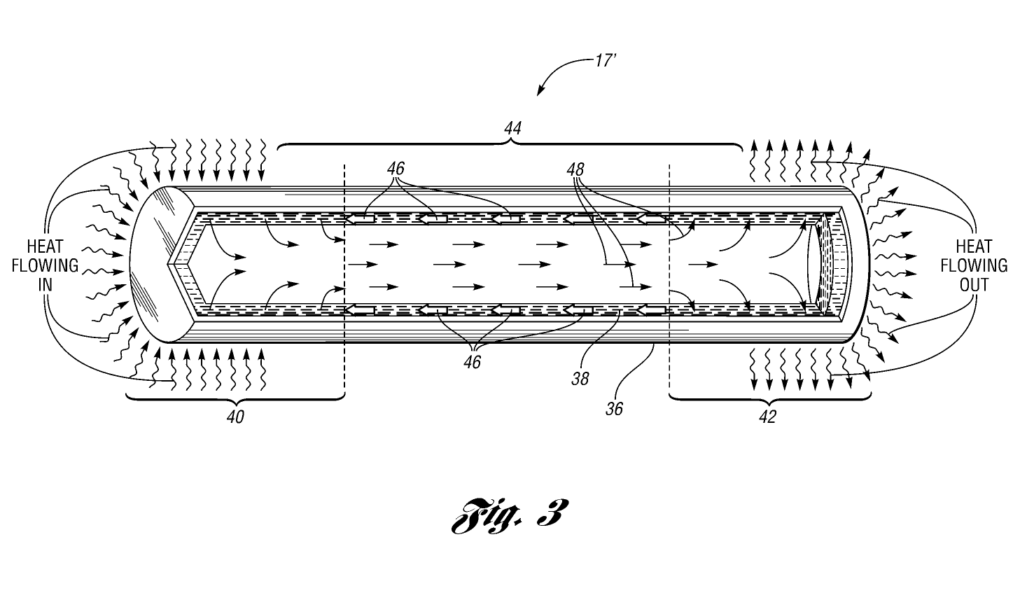

With reference to FIG. 1, a brake caliper 10 receives brake pads 12 and a periphery 14 of a brake rotor 16. The brake caliper 10 includes heat pipes 17 and a caliper body 18. The caliper body 18 includes an inboard portion 20, an outboard portion 22, and a connector 24. During use, the inboard portion 20 faces toward the inside of a vehicle as indicated by the arrow labeled “INBOARD” while the outboard portion 22 faces toward the outside of the vehicle, which is in the opposite direction of the inboard portion 20 or “rim side” of the brake rotor 16. Either the inboard portion 20, the outboard portion 22, or both the inboard and outboard portions 20, 22 have piston bores 26 (illustrated in FIGS. 2 and 4-6). For example, each portion of the caliper body 18 may include three or four piston bores, which may or may not vary in size.

With continuing reference to FIG. 1, the inboard portion 20 is spaced relative to the outboard portion 22. The connector 24 connects the inboard portion 20 and the outboard portion 22 to provide spacing between the inboard and outboard portions 20, 22. The spacing between the inboard and outboard portions 20, 22 permits the brake pads 12 and the periphery 14 of the brake rotor 16 to be received between the inboard portion 20 and the outboard portion 22. The brake pads 12 and the brake rotor 16 may have a normal operating temperature between 800° F. and 1100° F., but may operate at other temperatures. The normal operating temperature of the brake pads 12 and the brake rotor 16 may allow for more efficient braking of the vehicle.

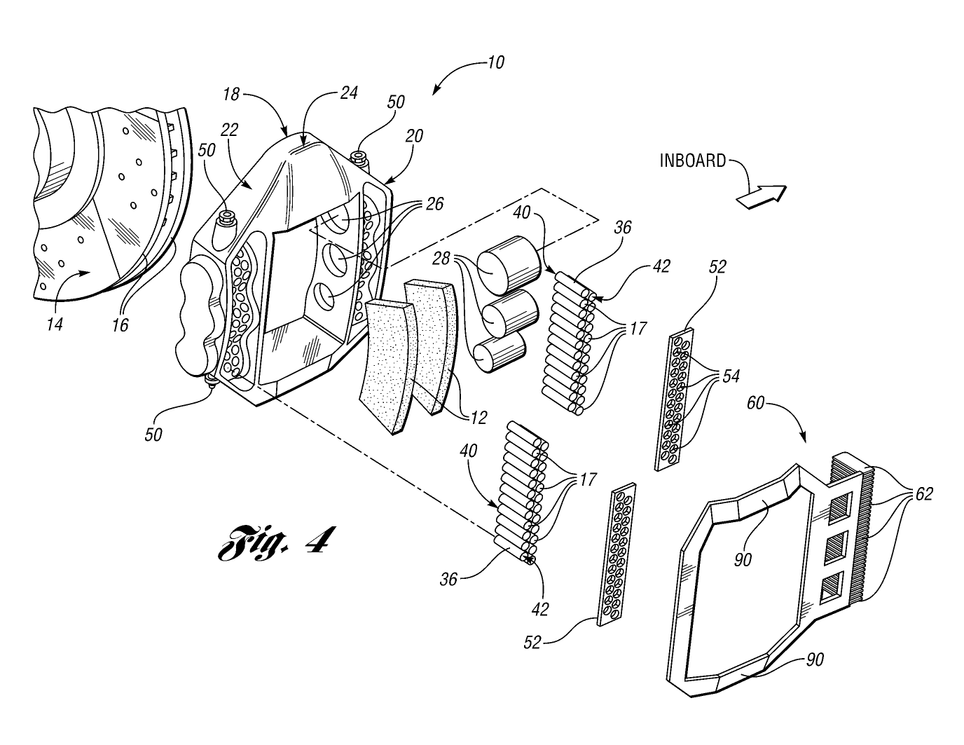

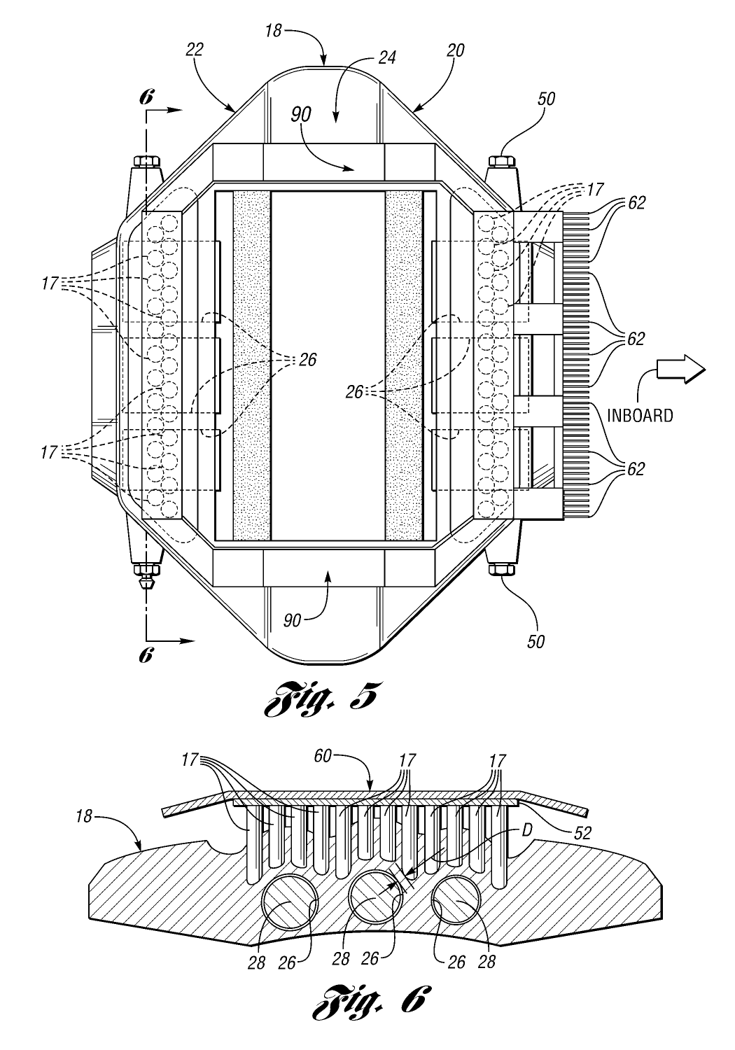

As illustrated in FIG. 2, the brake caliper 10 includes pistons 28 (also illustrated in FIGS. 4 and 6). The pistons 28 are received within the piston bores 26 of the brake caliper 10. During braking of the vehicle, when brake fluid (not illustrated) moves the pistons 28 and the brake pads 12 toward the brake rotor 16, the pistons 28 press the brake pads 12 against the periphery 14 of the brake rotor 16. When the pistons 28 press the brake pads 12 against the periphery 14 of the brake rotor 16, friction occurs between the brake pads 12 and the periphery 14 of the brake rotor 16 thereby heating the brake pads 12. As the temperature of the brake pads 12 increases, heat 30 transfers from the brake pads 12 to the pistons 28, which heats the brake fluid in the brake caliper 10. As the brake fluid heats, the brake fluid near the pistons 28 in the brake caliper 10 may heat to a higher temperature than brake fluid elsewhere in the brake caliper 10.

With continuing reference to FIG. 2, the heat pipes 17 are at least partially embedded within the caliper body 18. In one example, the caliper body 18 may expose a portion of the heat pipes 17. In another example, the heat pipes 17 may be completely embedded within the caliper body 18. The heat pipes 17 are included in the portions of the caliper body 18 having the piston bores 26. Therefore, either the outboard portion 22, the inboard portion 20, or both the inboard and outboard portions 20, 22 have the heat pipes 17.

Brazing may be used to embed the heat pipes 17 within openings in the caliper body 18 (illustrated in FIG. 4), however other methods may be used. For example, a clamp (not shown) may be used to support the heat pipes 17 within the caliper body 18. The clamp may be on two sides of each of the heat pipes 17.

Once positioned in the caliper body 18, a material may be deposited around the heat pipes 17 and in the caliper body 18 near the piston bores 26 to support the heat pipes 17 in the caliper body 18. The material may be a copper alloy, an aluminum alloy, and/or graphite to increase the transfer of heat away from the caliper body 18.

With reference to FIG. 3, each 17′ of the heat pipes 17 of the brake caliper 10 include a housing 36, an evaporator end 40, a condenser end 42, and a working fluid or coolant 44 enclosed therein. The evaporator end 40 is embedded in the brake caliper 10 where heat is to be removed. The condenser end 42 is spaced away from the evaporate end 40 to a position where heat can dissipate away from the heat pipe 17′. The heat pipe 17′ transfers thermal energy or heat (illustrated as “HEAT FLOWING IN”) from the evaporator end 40 to the condenser end 42 via the working fluid 44. The working fluid 44 may include water, methanol, ammonia, acetone, sodium, mercury, another suitable working fluid, or a combination thereof. In addition, the heat pipe 17′ may include a wick 38.

With continuing reference to FIG. 3, the housing 36 encloses the working fluid 44, the wick 38, the evaporator end 40, and the condenser end 42 to allow the working fluid 44 to evaporate in the evaporator end 40 and condense in the condenser end 42. Furthermore, the housing 36 may be made of various materials having different thermal conductivity properties, such as a copper alloy or an aluminum alloy.

With continuing reference to FIG. 3, the working fluid 44 evaporates from a liquid state 46 to a gaseous state 48 in the evaporator end 40. Once in the gaseous state 48, the working fluid 44 transfers the heat (illustrated as “HEAT FLOWING IN”) from the evaporator end 40 toward the condenser end 42. As the working fluid 44 moves toward the condenser end 42, the working fluid 44 carries the heat toward the condenser end 42. As the working fluid 44 enters the condenser end 42, the working fluid 44 condenses from the gaseous state 48 to the liquid state 46. When the working fluid 44 condenses, the working fluid 44 releases the heat (illustrated as “HEAT FLOWING OUT”) in the condenser end 42 of the heat pipe 17′. In addition, the working fluid 44 may enter a wick 38, which transports the working fluid 44 from the condenser end 42 back to the evaporator end 40 where the working fluid 44 can evaporate again. The wick 38 may include a sintered metallic powder or a series of grooves extending between the evaporator end 40 and the condenser end 42.

The heat pipes 17 may or may not be the same. For example, one or more of the heat pipes 17 may be of a different size, length, width, or shape to allow the heat pipes 17 to cool the brake caliper 10 as well as the brake fluid at different rates in the piston bores 26. The heat pipes 17 may be cylindrical in shape (as shown in FIGS. 4-5) or the heat pipes 17 may be thin in profile. As the heat pipes 17 become thinner in profile, the surface area of the heat pipes 17 is increased, which increases the rate the heat pipes 17 transport heat from the evaporator end 40 toward the condenser end 42. Increasing the transport rate of the heat pipes 17 is one way to increase the efficiency of the heat pipes 17, and thus the cool the brake caliper 10 as well as the brake fluid in the brake caliper 10 more efficiently. Furthermore, one or more of the heat pipes 17 may have a range of motion to enhance flexibility of the heat pipes 17, which may be desirable if the caliper body 18 expands or contracts due to thermal expansion. In another example, the heat pipes 17 may include one or more thermal pins, such as those provided by Noren™ Products, Incorporated. In such an example, all the heat pipes 17 may be thermal pins or only a few of the heat pipes 17 may be thermal pins.

A thermal pin is a type of heat pipe. The thermal pin cools at relatively high operating temperatures, typically up to about 1200° F. Thermal pins may be desired or necessary if the brake caliper 10 or brake fluid in the brake caliper 10 exceeds 350° F. Noren™ Products, Incorporated is one provider of thermal pins. Conventional heat pipes typically operate up to 350° F. In comparison, thermal pins typically have a thicker housing wall than conventional heat pipes. In addition, thermal pins have solder joints with a higher melding point than conventional heat pipes. Therefore, the solder joints of the thermal pins may seal the working fluid 44 better than conventional heat pipes. It is important to seal the working fluid 44 in the heat pipes 18 to prevent the working fluid 44 from escaping the heat pipes 17. Furthermore, thermal pins operate more efficiently at higher temperatures than conventional heat pipes. Consequently, the thermal pins may cool the brake caliper 10 and the brake fluid in the brake caliper 10 faster than convention heat pipes and reduce the likelihood of overheating the brake fluid. A skilled artisan would find thermal pins are desirable for other reasons.

As depicted in FIG. 4, the brake caliper 10 may include a fluid passage 50 in fluid communication with the piston bores 26 to supply brake fluid (not illustrated) to the piston bores 26. The fluid passage 50 may extend between the inboard and outboard portions 20, 22 of the caliper body 18 without being embedded in the connector 24 (as shown in FIG. 4). Alternatively, the fluid passage 50 may extend from the inboard portion 20, through the connector 24, and into the outboard portion 22 of the caliper body 18.

As shown in FIG. 4, the brake caliper 10 may include a collar 52 defining a plurality of openings 54. The collar 52 receives the heat pipes 17 in the openings 54 to support the heat pipes 17 in a predetermined configuration. The collar 52 may be made of any suitable material, such as aluminum or copper alloy. The predetermined configuration may be an in-line configuration and/or staggered configuration. For example, the in-line configuration may include the heat pipes 17 arranged in one or more rows or columns. The staggered configuration may include the heat pipes 17 arranged so as to avoid crowding of the heat pipes 17 in the collar 52 (as illustrated in FIG. 5). In such an example, the staggered configuration may have the heat pipes 17 spaced equally from each adjacent heat pipe.

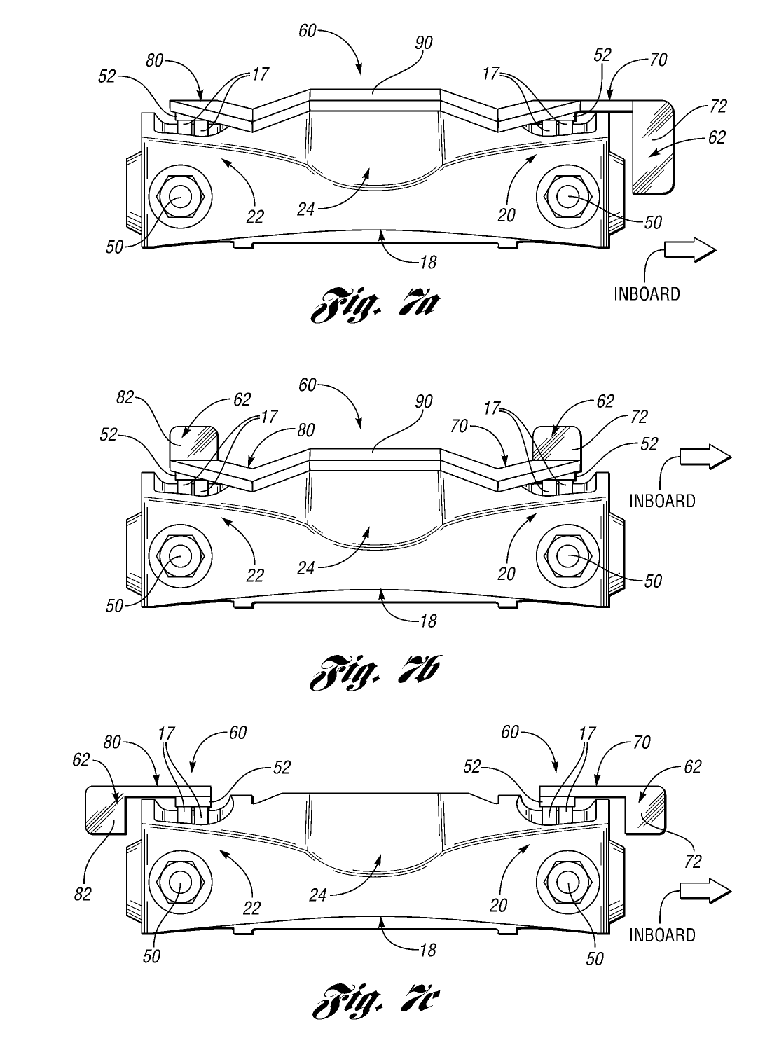

With reference to FIG. 4, the brake caliper 10 may include a radiator 60 having fins 62. The radiator 60 extends away from at least some of the heat pipes 17 to transfer heat away from the evaporator end 40 of the heat pipes 17. As heat increases in the radiator 60, the fins 62 transfer heat away from the radiator 60. The fins 62 increase the surface area of the radiator 60 to increase the rate of heat transfer away from the radiator 60. The radiator 60 as well as the fins 62 may be made of any suitable material having a relatively high thermal conductivity, such as a copper alloy, an aluminum alloy, or both copper and aluminum. In addition, the radiator 60 may include an auxiliary heat pipe 90 (also shown in FIGS. 7(a)-5(b)). The auxiliary heat pipe 90 is disposed in the radiator 60 to transfer heat from one end of the radiator 60 to another end having the fins 62. The auxiliary heat pipe 90 functions similar to the heat pipes 17, but may be longer in length.

With reference to FIGS. 5-6, the heat pipes 17 may be embedded in any suitable position within the caliper body 18 to cool the brake caliper 10 and the brake fluid (not illustrated) in, around, or near the piston bores 26. In one example, some the heat pipes 17 may embedded around and/or between each of the piston bores 26. In another example, the piston bores 26 may have a circular cross section and may be embedded radially around each of the piston bores 26 (as shown in FIG. 6). In addition, the heat pipes 17 may be embedded in an arrangement within the caliper body 18, such as an in-line arrangement or staggered arrangement. For example, the in-line arrangement may include the heat pipes 17 arranged in one or more rows or columns. The staggered arrangement may include the heat pipes 17 arranged so as to avoid crowding of the heat pipes 17 in the caliper body 18. For example, the staggered arrangement may have the heat pipes 17 spaced equally from each adjacent heat pipe in the caliper body 18.

With continuing reference to FIGS. 5-6, the heat pipes 17 transfer heat away from the piston bores 26. When the heat pipes 17 transfer heat away from the piston bores 26, the heat pipes 17 cool the brake caliper 10 and the brake fluid (not illustrated) in or around the piston bores 26. In addition, the heat pipes 17 may transfer heat away from other areas of the brake caliper 10. For example, the heat pipes 17 may be embedded in the inboard portion 20 and/or outboard portion 22 to cool the fluid passage 50 and the brake fluid flowing through the fluid passage 50. Thus, the heat pipes 17 may transfer heat away from the brake caliper 10 and brake fluid flowing through the fluid passage 50.

With reference to FIG. 6, the heat pipes 17 may be embedded within the caliper body 18 at different depths. Thus, the distance between the heat pipes 17 and the piston bores 26 in the caliper body 18 may vary. The distance may vary depending on the material of the caliper body 18, the performance of the heat pipes 17, and/or the braking requirements of the brake caliper 10. For example, the heat pipes 17 may be embedded within the caliper body 18 relatively close to the piston bores 26 to increase the efficiency of cooling the brake caliper 10 and the brake fluid in or around the piston bores 26.

Referring to FIG. 6, the shortest distance “D” between the heat pipes 17 and the piston bores 26 maybe between one-sixteenth of an inch ( 1/16″) and one inch (1″). In another example, the shortest distance “D” between the heat pipes 17 and the piston bores 26 may be between one-eighth of an inch (⅛″) and one-half of an inch (½″). In yet another example, the shortest distance “D” between the heat pipes 17 and the piston bores 26 is approximately one-quarter of an inch (¼″).

As generally illustrated in FIGS. 7(a)-7(c), the fins 62 may be positioned or arranged on the radiator 60 in any suitable configuration or arrangement to transfer heat away from the radiator 60. In addition, the fins 62 may be positioned or arranged on the radiator 60 in an effort to maximize air flow (not illustrated) around the fins 62. Ducts (not illustrated) in the vehicle may provide the air flow to the fins 62 as the vehicle is driven. Furthermore, the ducts may include a fan (not shown) to assist increase the speed of the air flow to the fins 62. The air flow through the ducts is used to cool the fins 62 and therefore cool the brake caliper 10 and the brake fluid in the brake caliper 10.

Referring to FIGS. 7(a)-7(c), the radiator 60 may include either an inboard radiator portion 70 having inboard fins 72, an outboard radiator portion 80 having outboard fins 82, or both the inboard and outboard radiator portions 70, 80, at least one of which has fins 62. If the radiator 60 has both the inboard and outboard radiator portions 70, 80, then it should be understood that either the inboard radiator portion 70 has the inboard fins 72 (as illustrated in FIG. 5(a)), the outboard radiator portion 80 has outboard fins 82 (not shown), or both the inboard and outboard radiator portions 70, 80 have respective fins 34, 36 (as illustrated in FIG. 5(b)-5(c)).

As depicted in FIG. 7(a), the radiator 60 has the inboard radiator portion 70 with the inboard fins 72 and the outboard radiator portion 80 without fins. The inboard radiator portion 70 extends away from the evaporator end 40 of the heat pipes 17 in the inboard portion 20 of the caliper body 18. In addition, the radiator 60 may include the auxiliary heat pipe 90 extending from the outboard radiator portion 80 to the inboard radiator portion 70. In operation, the auxiliary heat pipe 90 transfers heat from the heat pipes 17 in the outboard portion 22 of the caliper body 18 to the inboard radiator portion 70. The inboard radiator portion 70 receives heat from both the inboard and outboard portions 20, 22 and transfers the heat to the inboard fins 72. The inboard fins 72 dissipate the heat away from the radiator 60.

As generally illustrated in FIGS. 7(b) and 7(c), the radiator 60 has both the inboard and outboard radiator portions 70, 80 having respective inboard fins 72 and outboard fins 82. The inboard radiator portion 70 transfers heat from the heat pipes 17 in the inboard portion 20 of the caliper body 18 to the inboard fins 72. Likewise, the outboard radiator portion 80 transfers heat from the heat pipes 17 in the outboard portion 22 of the caliper body 18 to the outboard fins 82. In addition, the radiator 60 may include the auxiliary heat pipe 90 extending and transferring from the outboard radiator portion 80 to the inboard radiator portion 70.

Referring to FIG. 7(b), the inboard fins 72 and the outboard fins 82 extend in the same direction. The inboard and outboard fins 72, 82 may extend in the same direction away from the caliper body 18 and the brake rotor 16 (shown in FIG. 1) in an effort to maximize the air flow around the fins 72, 82. In such an example, the air flow to the brake caliper 10 may be relatively high where the inboard and outboard fins 72, 82 are arranged with respect to the caliper body 18. The greater the rate of air flow around the inboard and outboard fins 72, 82, the more efficient the inboard and outboard fins 72, 82 can transfer heat away from the radiator 60.

Referring FIG. 7(c), the inboard fins 72 and the outboard fins 82 extend in generally opposite directions. The inboard and outboard fins 72, 82 may extend in generally opposite directions an effort to maximize the air flow around the fins 72, 82. In such an example, the air flow to the brake caliper 10 may be relatively high on sides of the sides of the caliper body 18 facing the inboard and outboard fins 72, 82. Other arrangements of the fins 62 with respect to the brake caliper 10 are also possible. The fins 62 may be arranged for other reasons than trying to increase the air flow around the fins 72, 82.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A brake caliper comprising:
a caliper body including spaced inboard and outboard portions, at least one of the portions having piston bores, and the caliper body further including a connector between the inboard and outboard portions whose spacing permits brake pads and a periphery of a brake rotor to be received between the inboard and outboard portions;
pistons disposed in the piston bores to press the brake pads against the periphery of the brake rotor when brake fluid moves the pistons and the brake pads toward the brake rotor; and
heat pipes at least partially embedded within the caliper body to transfer heat away from the piston bores thereby cooling the brake fluid in the piston bores.

2. The brake caliper of claim 1, wherein both the inboard and outboard portions include the piston bores and the heat pipes.

3. The brake caliper of claim 1, wherein the heat pipes are at least partially embedded around each of the piston bores.

4. The brake caliper of claim 1, wherein the shortest distance between the heat pipes and the piston bores is between one-sixteenth of an inch and one inch.

5. The brake caliper of claim 4, wherein the shortest distance between the heat pipes and the piston bores is between one-eighth and one-half inch.

6. The brake caliper of claim 1, further comprising a collar to receive and support the heat pipes in a predetermined configuration.

7. The brake caliper of claim 1, further including a radiator extending away from the heat pipes and having fins for transferring heat away from the radiator.

8. The brake caliper of claim 7, wherein the radiator includes an auxiliary heat pipe to transfer heat from the heat pipes to the fins of the radiator.

9. The brake caliper of claim 8, wherein both the inboard and outboard portions of the caliper body include the piston bores and the heat pipes and the radiator includes an inboard radiator portion having inboard fins and an outboard radiator portion, the auxiliary heat pipe extending from the outboard radiator portion to the inboard radiator portion to transfer heat from the outboard radiator portion to the inboard fins.

10. The brake caliper of claim 8, wherein both the inboard and outboard portions include the piston bores and the heat pipes and the radiator includes an inboard radiator portion having inboard fins and an outboard radiator portion having outboard fins, the inboard radiator portion transferring heat from the heat pipes in the inboard portion of the caliper body to the inboard fins, and the outboard radiator portion transferring heat from the heat pipes in the outboard portion of the caliper body to the outboard fins.

11. The brake caliper of claim 10, wherein the inboard fins and the outboard fins extend in generally opposite directions.

12. The brake caliper of claim 10, wherein the inboard fins and the outboard fins extend in the same direction.

13. The brake caliper of claim 1, further including a fluid passage in fluid communication with the piston bores to supply brake fluid to the piston bores.

14. The brake caliper of claim 1, wherein the fluid passage is disposed within the inboard and outboard portions and the heat pipes transfer heat away from brake fluid flowing through the fluid passage.

15. The brake caliper of claim 1, wherein each of the heat pipes includes a working fluid, an evaporator end embedded in the caliper body, and a condenser end, the working fluid transferring heat from the evaporator end toward the condenser end.

16. The brake caliper of claim 1, wherein the heat pipes include one or more thermal pins.

17. A disk brake comprising:
a brake caliper having piston bores; and
one or more heat pipes at least partially embedded within the brake caliper to transfer heat away from the piston bores thereby cooling brake fluid in the piston bores.

18. A brake caliper comprising:
a caliper body including an inboard portion having inboard piston bores, an outboard portion spaced from the inboard portion and having outboard piston bores, and a connector between the inboard and outboard portions whose spacing permits brake pads and a periphery of a brake rotor to be received between the inboard and outboard piston bores;
pistons disposed in the inboard and outboard piston bores to press the brake pads against the periphery of the brake rotor when brake fluid moves the pistons and the brake pads toward the brake rotor;
heat pipes at least partially embedded within the inboard and outboard portions to transfer heat away from respective inboard and outboard piston bores thereby cooling the brake fluid in the inboard and outboard piston bores; and
a radiator extending away from the heat pipes and having an auxiliary heat pipe and fins, the auxiliary heat pipe distributing heat within the radiator and the fins transferring heat away from the radiator.

19. The brake caliper of claim 18, further including a fluid passage disposed within the inboard and outboard portions and in fluid communication with the inboard and outboard piston bores, the fluid passage supplying brake fluid to the inboard and outboard piston bores and the heat pipes transferring heat away from brake fluid flowing through the fluid passage.

20. The brake caliper of claim 18, wherein the shortest distance between the heat pipes and the piston bores is between one-eighth and one-half of an inch.
